(19) United States
(12) Patent Application Publication
(10) Pub. No.: US 2026/0161369 A1
(43) Pub. Date: Jun. 11, 2026

(54) METHOD, APPARATUS, DEVICE FOR CREATING A WORKFLOW AND STORAGE MEDIUM

(71) Applicant: Beijing Zitiao Network Technology Co., Ltd., Beijing (CN)

(72) Inventor: Xuneng HUANG, Beijing (CN)

(21) Appl. No.: 19/187,595

(22) Filed: Apr. 23, 2025

(30) Foreign Application Priority Data
Dec. 11, 2024 (CN) 202411826129.8

(51) Int. Cl. G06F 8/34

(52) U.S. Cl. CPC G06F 8/34

(57) ABSTRACT

The disclosure relates to a method, apparatus, device for creating a workflow and a storage medium. An example method herein includes presenting a canvas component for editing a node graph of a workflow; receiving, via the canvas component, an editing operation associated with the node graph and for configuring at least one action associated with the workflow, the at least one action configured to manage a trigger associated with the workflow; and creating the workflow based on the editing operation.

### CROSS-REFERENCE

The present application claims priority to Chinese Patent Application No. 202411826129.8, filed on Dec. 11, 2024, and entitled “METHOD, APPARATUS, DEVICE FOR CREATING A WORKFLOW AND STORAGE MEDIUM”, the entirety of which is incorporated herein by reference.

### FIELD

Example embodiments of the present disclosure generally relate to the field of computers, and in particular, to a method, apparatus, device for creating a workflow, and computer-readable storage media.

### BACKGROUND

With the development of computer technologies, people may create and post various types of applications through some platforms. In the development process of applications, the creation and management of workflows is an important task. For example, the user may indicate the processing flow of the request by editing a node in the workflow.

### SUMMARY

In a first aspect of the present disclosure, there is provided a method for creating a workflow. The method includes presenting a canvas component for editing a node graph of a workflow; receiving, via the canvas component, an editing operation associated with the node graph and for configuring at least one action associated with the workflow, the at least one action configured to manage a trigger associated with the workflow; and creating the workflow based on the editing operation.

In a second aspect of the present disclosure, an apparatus for creating a workflow is provided. The apparatus includes a presentation module configured to present a canvas component for editing a node graph of a workflow; a receiving module configured to receive, via the canvas component, an editing operation associated with the node graph and for configuring at least one action associated with the workflow, the at least one action configured for managing a trigger associated with the workflow; and a creation module configured to create the workflow based on the editing operation.

In a third aspect of the present disclosure, an electronic device is provided. The apparatus includes at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer-readable storage medium is provided. The computer-readable storage medium stores a computer program, and the computer program is executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIGS. 2A-2E illustrate example interfaces in accordance with some embodiments of the present disclosure;

FIG. 3 illustrates a flowchart of an example process of creating a workflow according to some embodiments of the present disclosure;

FIG. 4 illustrates a schematic structural block diagram of an example apparatus for creating a workflow according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for example purposes only and are not intended to limit the protection scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiment described in the same section/subsection and/or different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or same objects. Other explicit and implicit definitions may also be included below.

Embodiments of the present disclosure may relate to data of a user, obtainment and/or usage of data, and the like. These aspects all follow the corresponding laws and regulations and related regulations. In the embodiments of the present disclosure, all data is collected, obtained, processed, treated, forwarded, used, etc., all of which are performed on the premise that the user knows and confirms. Accordingly, when implementing the various embodiments of the present disclosure, the types of the data or information, the usage scope, the usage scenario that may be involved, and the like should be notified to the user and obtain the authorization of the user in an appropriate manner according to the relevant laws and regulations. The specific notification and/or authorization manner may vary according to actual situations and application scenarios, and the scope of the present disclosure is not limited in this regard.

The solutions in the present specification and the embodiments, for example, personal information processing involved, may be processed on the premise of having a legality basis (for example, obtaining consent of a personal information subject, or necessary for performing a fulfillment contract), and processing only within a specified or agreed range. The user rejects processing personal information other than necessary information required by the basic function, and does not affect the basic function used by the user.

Some platforms also support users to configure various types of applications, such as agents or bots based on generative models. However, the existing workflow has limited support for triggers, which brings great constraints on the usage scenario of the workflow.

The embodiment of the disclosure provides a method for creating a workflow. The method includes presenting a canvas component for editing a node graph of a workflow; receiving, via the canvas component, an editing operation associated with the node graph and for configuring at least one action associated with the workflow, the at least one action configured to manage a trigger associated with the workflow; and creating the workflow based on the editing operation.

In this manner, embodiments of the present disclosure may support managing triggers of workflows through a canvas component, thereby improving flexibility and efficiency of managing triggers.

Various example implementations of this method are described in detail below in conjunction with the accompanying drawings.

### Example Environment

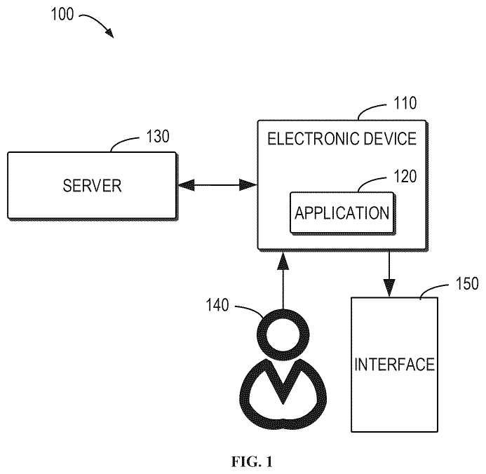

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interface interaction. Application 120 may be any suitable type of application for interface interaction, examples of which may include, but are not limited to, development applications or other suitable applications. The user 140 may interact with the application 120 via the electronic device 110 and/or its attachment device.

In the environment 100 of FIG. 1, if the application 120 is in an active state, the electronic device 110 may present, via the application 120, an interface 150 for supporting creation of a workflow.

In some embodiments, the electronic device 110 communicates with the server 130 to implement provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, may also be a server cluster composed of multiple physical servers, or a distributed system, or may further be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this regard. In an embodiment of the present disclosure, the server 130 and the electronic device 110 may implement signaling interaction through a communication connection between the server 130 and the electronic device 110.

It should be understood that the structures and functions of the various elements in the environment 100 are described for example purposes only and do not imply any limitation to the scope of the present disclosure.

Some example embodiments of the present disclosure will be described below with continued reference to the accompanying drawings.

### Example Interaction

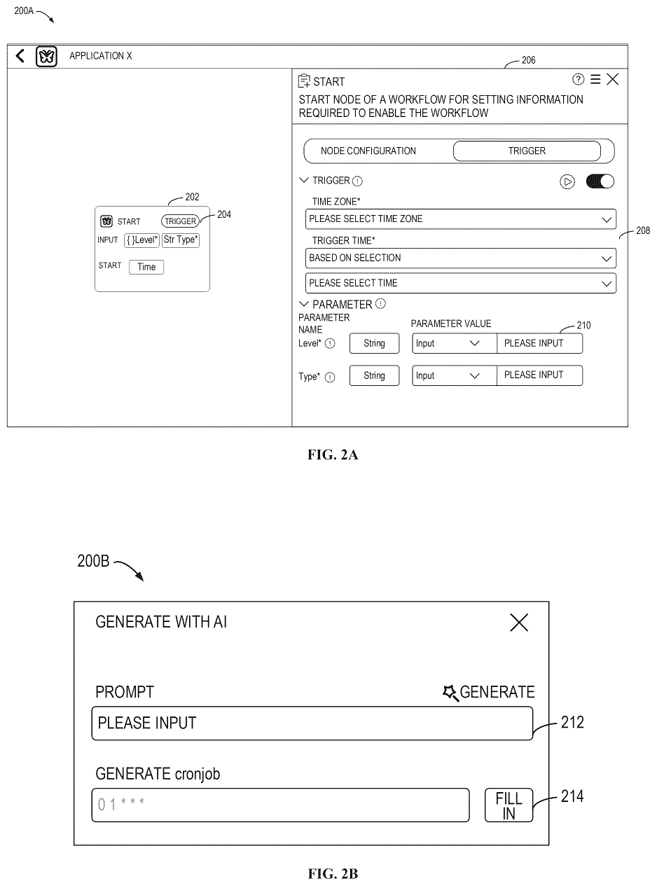

An example interaction of creating a workflow according to some embodiments of the present disclosure will be described below in conjunction with FIGS. 2A-2E. FIGS. 2A-2E illustrate example interfaces 200A-200F, in accordance with some embodiments of the present disclosure. The interfaces 200A-200F may be provided, for example, by the electronic device 110 shown in FIG. 1.

As shown in FIG. 2A, the interface 200A may correspond to an editing interface of the workflow. As an example, the editing interface 200A may include a canvas component for editing a node connection diagram corresponding to the workflow.

In some embodiments, interface 200A may also be associated with an application to be created. As an example, the application may be associated with one or more workflows, and the interface 200A may correspond to an editing interface of the workflow associated with the application.

As shown in FIG. 2A, in the interface 200A, the electronic device 110 may support various types of node editing operations of the user, such as adding nodes, deletion nodes, connecting nodes, modifying node attributes, and the like into the canvas component.

As will be described in detail below, the electronic device 110 may support a user configuring actions associated with a workflow through a canvas component, such actions may be used to manage one or more triggers associated with the workflow.

As shown in FIG. 2A, the canvas component may include a node 202, the electronic device 110 may receive a selection of the node 202, and may present a configuration window 206 for corresponding trigger configuration information. As an example, the node 202 may be a preset node in the workflow, for example, a start node.

In some embodiments, the electronic device 110 may support the creation action of configuring the trigger in the configuration window 206 of the starting node 202. As an example, as shown in FIG. 2A, the electronic device 110 may provide an on opening button for opening the trigger in the configuration window 206.

Further, the configuration window 206 may include a triggering condition for configuring to be associated with the trigger to be created. In some embodiments, a trigger may be associated with two types of conditions, i.e., a time condition and an event condition. The time condition may indicate, for example, a triggering time of the trigger, and the event condition may indicate a triggering event of the trigger.

Taking the time condition as an example, the time condition may include “10 am per day”. Such a time condition may indicate a periodic time, or fixed some time.

Taking FIG. 2A as an example, the electronic device 110 may provide a control 208 for configuring the time condition in the configuration window 206. As an example, the electronic device 110 may determine, via the control 208, a time zone included in the triggering condition, and a specific triggering time. For example, the user may select a “based on selection” mode and may select the specific triggering time from the drop down box.

In some embodiments, the electronic device 110 may further support generating an expression related to the triggering time, for example, a cronjob expression. As an example, the electronic device 110 may select the “smart generation” mode via the control 208, and may accordingly present the generation window 200B as shown in FIG. 2B.

In FIG. 2B, the electronic device 110 may acquire a natural language text input by the user via the control 212. The natural language text may, for example, describe a triggering time of the desired configuration, e.g., “1 am per day”. Further, the electronic device 110 may receive a triggering for the “generation” button, and may process the natural language text using the language model to generate an expression corresponding to the triggering time. For example, the generated expression may be “01 * * *”.

As an example, the electronic device 110 may receive a selection of the control 214, and may fill the expression into the control 208, thereby completing the configuration of the triggering time.

In some embodiments, the configuration window 206 may also support configuration of event conditions associated with the created trigger, for example. As an example, the event condition may include detecting a certain event in an application. In some scenarios, such applications may include applications created based on workflows, or other suitable applications.

In some embodiments, the configuration window 206 may, for example, support configuring a trigger as an event trigger, and may provide controls for configuring event conditions. In some examples, the electronic device 110 may configure the event condition as a first application event within a target application associated with the workflow via a control.

As an example, the target application may include an application created via the editing interface 200A. Correspondingly, such a first application event may include, for example, detecting a button click event, a content input event, and the like in the graphical interface corresponding to the application.

As another example, the target application may further include at least one configured application. Such at least one application may be added based on a user's authorization. For example, such an application may include a third-party application that is different from the target application.

In some embodiments, where an application authorization is obtained, the electronic device 110 may present a set of application program interface APIs associated with the application. Further, the electronic device 110 may receive a selection of at least one API of the set of APIs, and may configure an event condition accordingly, the event condition including an application event corresponding to the selected at least one API.

As an example, such an API may be a set of open APIs provided by a media application. For example, the user may select a content posting API and may configure the event condition as the current user posting new content within the media application.

Additionally, as shown in FIG. 2A, the electronic device 110 may further provide a control 210 in the configuration window 206 to configure the input parameter of the workflow corresponding to the trigger.

In this way, embodiments of the present disclosure may support binding a preset node in a workflow with a trigger, so that when a triggering condition of a trigger is met, the preset node will be automatically triggered to execute.

In some scenarios, such a trigger may also be referred to as a system trigger, and the preset node may include, for example, a start node of the workflow. Additionally, where the start node 202 is configured to be associated with a trigger creation action, the electronic device 110 may, for example, display an indication element 204 in the node 202 to indicate that the start node 202 is bound with a trigger.

In some embodiments, the electronic device 110 may further provide one or more trigger processing nodes in the canvas component to support the user adding a corresponding trigger processing node to the workflow to configure a corresponding trigger management action.

In some examples, the electronic device 110 may support adding a trigger setting node to the canvas component. FIG. 2C illustrates an example trigger setting node 220 and a corresponding configuration window 222.

In some embodiments, the trigger setting node 220 may be used, for example, to create a new trigger, or modify an existing trigger. As an example, the configuration window 222 includes a control 216 to input a name of a trigger to be created or set.

As an example, if the name of the input is a new name, the trigger setting node 220 may be used to perform a trigger creation action. As another example, if the name of the input is an existing name, the trigger setting node 220 may be used to perform a trigger modification action.

In some scenarios, the electronic device 110 may also separate the functions of the trigger creation and trigger editing, for example, as an example, the electronic device 110 may support adding a trigger creation node and a trigger editing node to the canvas component.

Similar to the configuration window 206 described above, the electronic device 110 may provide a control 218 to configure the triggering condition of the trigger. As discussed above, such triggering conditions may include a time condition or an event condition. For a specific configuration process of the triggering condition, it may refer to the content described above with respect to the control 208, and details are not described herein again.

In addition, unlike the configuration window 206, the configuration window 222 may also provide a control 224 to support binding the created or set trigger to a specified workflow. As an example, the user may select the target workflow to be bound by clicking on the “+” button. Such workflows may include currently edited workflows, workflows associated with applications to be created, or other workflows that the user authorizes access, etc.

In the event that the trigger is bound to the target workflow (e.g., workflow X), if the triggering condition of the trigger is met, the bound target workflow (e.g., workflow X) may be automatically met.

In some scenarios, a trigger created via the setting node 220 may also be referred to as a user trigger. Since the system trigger mentioned above is naturally bound to the corresponding workflow, it does not support binding the system trigger to other workflows.

Further, as shown in FIG. 2C, the configuration window 222 may also indicate an output parameter 226 of the trigger setting node 220, for example, an identifier of a created or edited trigger.

In some embodiments, the electronic device 110 may further support adding a trigger deletion node to the canvas component, to delete the specified trigger. For example, the input parameter corresponding to such a trigger deletion node may include an identifier of the trigger to be deleted, and the output parameter thereof may include whether the trigger is successfully deleted.

In some embodiments, the electronic device 110 may also support adding a trigger lookup node (also referred to as a trigger read node) to the canvas component. FIG. 2D illustrates an example trigger lookup node 228 and a corresponding configuration window 230.

As shown in FIG. 2D, the configuration window 230 may provide a control 232 to configure a lookup condition of the trigger. As an example, such lookup conditions may include an identification of a trigger or a user identification of a created trigger, or the like.

Additionally, the configuration window 230 may also display an output parameters 234 of the trigger lookup node 228. As an example, the trigger lookup node 228 may be configured to output a list of triggers that match lookup conditions, which may include, for example, an identification, a name, a time created, a triggering condition, a user identification, a workflow input parameter of various triggers, and the like.

In this way, embodiments of the present disclosure may support a user more flexibly managing triggers associated with a workflow by way of adding nodes to the workflow, thereby improving management efficiency associated with the triggers.

In some embodiments, the trigger configuration information obtained via the above may include a particular value directly input by the user through the control. In other embodiments, the trigger configuration information may also indicate an association between at least one parameter associated with the trigger to be managed and at least one variable in the workflow.

For example, the user may also configure the triggering condition of the trigger by applying a particular variable in the workflow. For example, the triggering time of the trigger may correspond to a certain time variable in the workflow. In this manner, embodiments of the present disclosure may further provide for dynamically managing the efficiency of a trigger during a workflow operation.

In some embodiments, at least one variable of the supported reference may be associated with a processing request received by the workflow. For example, in the event that the user inputs “10 am per day learning English” through the interactive interface associated with the workflow, the workflow may, for example, read the “10 am” variable from the processing request. In addition, based on the association relationship configured by the user, the variable may trigger to create a trigger whose triggering condition is “10 am”.

In this manner, embodiments of the present disclosure may further support dynamically managing triggers based on a user's request.

In some embodiments, as shown in FIG. 2E, the electronic device 110 may also present a trigger viewing interface 200E associated with the workflow. As shown, electronic device 110 may present description information of at least one trigger (e.g., trigger 236 and trigger 238) associated with the workflow in trigger viewing interface 20E.

As an example, such description information may include, but is not limited to, an identification, a name, a time created, a triggering condition (e.g., a triggering time), a user identification, a workflow input parameter of a trigger, and the like.

Additionally, the electronic device 110 may also provide one or more controls in the trigger viewing interface 200E. For example, the electronic device 110 may receive a selection of a deletion control of the trigger 236 to delete the trigger 236 in the workflow. As another example, the electronic device 110 may also receive a selection of a running control of the trigger 238, and may run the second trigger 238, for example. As an example, the trigger 238 may be enabled, and the bound workflow may be triggered to execute a corresponding process flow.

In this manner, embodiments of the present disclosure may support managing triggers of workflows through a canvas component, thereby improving flexibility and efficiency of managing triggers.

### Example Process

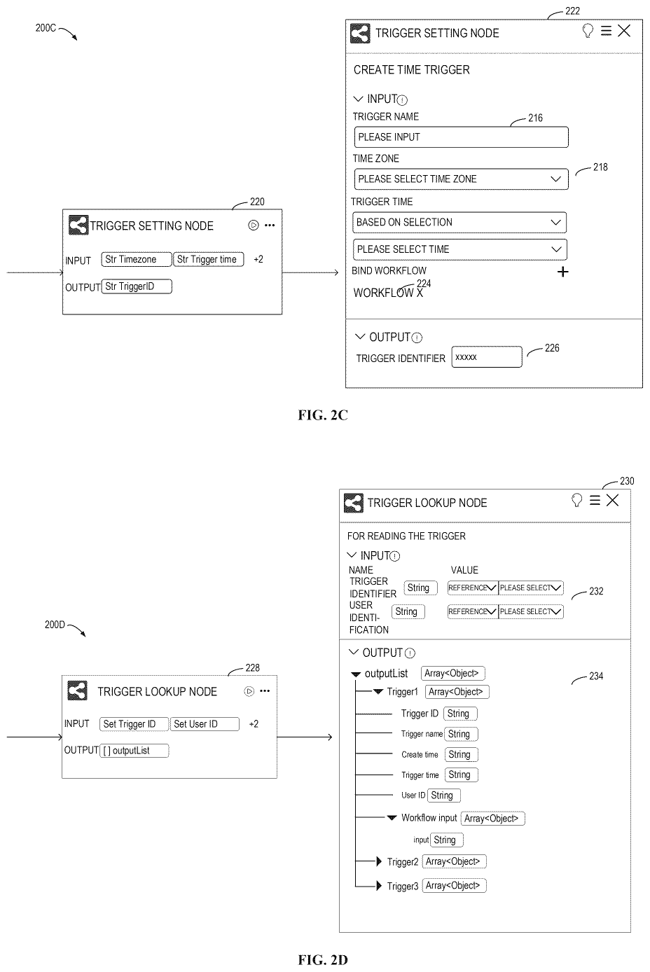

FIG. 3 illustrates a flowchart of a process 300 of creating a workflow according to some embodiments of the present disclosure. Process 300 may be implemented at electronic device 110. The process 300 is described below with reference to FIG. 1.

As shown in FIG. 3, at block 310, the electronic device 110 presents a canvas component for editing a node graph of a workflow.

At block 320, the electronic device 110 receives, via the canvas component, an editing operation associated with the node graph and for configuring at least one action associated with the workflow, the at least one action configured to manage a trigger associated with the workflow.

At block 330, the electronic device 110 creates the workflow based on the editing operation.

In some embodiments, the at least one action includes at least one of: a creation action for creating a new trigger associated with the workflow; a deletion action for deleting an existing trigger associated with the workflow; a modification action for modifying an attribute of an existing trigger associated with the workflow; a lookup action for looking up at least one trigger associated with the workflow.

In some embodiments, receiving an editing operation associated with the node graph includes: presenting a configuration window associated with a target node in the node graph; and obtaining, via a configuration window, a trigger configuration information associated with the target node.

In some embodiments, receiving an editing operation associated with the node graph further includes: adding a trigger processing node to the node graph as the target node, wherein the trigger processing node includes at least one of: a trigger setting node for creating a trigger and/or modifying a trigger; a trigger deletion node; or a trigger lookup node.

In some embodiments, the trigger configuration information indicates a triggering condition associated with a trigger to be managed, the triggering condition includes a time condition associated with a triggering time and/or an event condition associated with a triggering event.

In some embodiments, obtaining a trigger configuration information associated with the target node via a configuration window includes: obtaining, via a first control in the configuration window, a natural language text about a target triggering time; and generating, by a language model, an expression associated with the indicated target triggering time based on the natural language text.

In some embodiments, the event condition includes: a first application event within a target application associated with the workflow; and/or a second application event associated with at least one configured application that is different from the target application.

In some embodiments, obtaining a trigger configuration information associated with the target node via the configuration window includes: presenting a set of application program interfaces, APIs, associated with an application; and configuring the event condition in response to a selection of at least one API of the set of APIs, the event condition including an application event corresponding to the selected at least one API.

In some embodiments, the trigger configuration information indicates a target workflow bound to a trigger to be managed such that the target workflow is triggered to execute in response to a triggering condition of the trigger being met.

In some embodiments, the trigger configuration information indicates an association between at least one parameter associated with a trigger to be managed and at least one variable in the workflow.

In some embodiments, the at least one variable is associated with a processing request received by the workflow.

In some embodiments, receiving an editing operation associated with the node graph further includes: receiving a selection of a preset node in the node graph as the target node, the preset node including a start node of the workflow.

In some embodiments, the process 300 further includes presenting an indication element associated with the at least one node in response to at least one node in the node graph being associated with a trigger creation action.

In some embodiments, the process 300 further includes presenting a trigger viewing interface associated with the workflow; and presenting description information of at least one trigger associated with the workflow in the trigger viewing interface.

In some embodiments, the process 300 further includes: deleting the first trigger in response to a first operation on a first trigger of the at least one trigger; or executing the second trigger in response to a second operation on a second trigger of the at least one trigger.

### Example Apparatus and Device

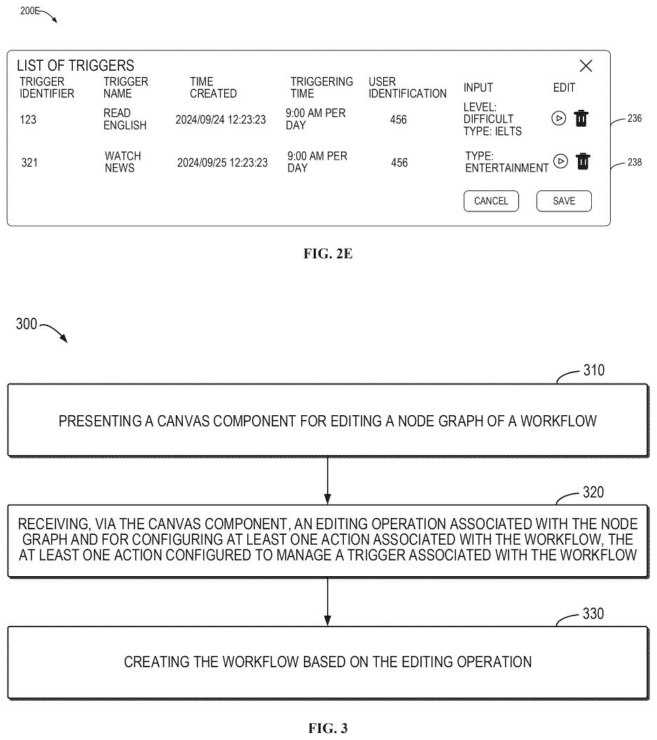

Embodiments of the present disclosure also provide a corresponding apparatus for implementing the above method or process. FIG. 4 illustrates a schematic structural block diagram of an example apparatus 400 for creating a workflow according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes a presentation module 410 configured to present a canvas component for editing a node graph of a workflow; a receiving module 420 configured to receive, via the canvas component, an editing operation associated with the node graph and for configuring at least one action associated with the workflow, the at least one action configured for managing a trigger associated with the workflow; and a creation module 430 configured to create the workflow based on the editing operation.

In some embodiments, the at least one action includes at least one of: a creation action for creating a new trigger associated with the workflow; a deletion action for deleting an existing trigger associated with the workflow; a modification action for modifying an attribute of an existing trigger associated with the workflow; a lookup action for looking up at least one trigger associated with the workflow.

In some embodiments, the receiving module 420 is further configured to present a configuration window associated with a target node in the node graph; and obtain, via a configuration window, a trigger configuration information associated with the target node.

In some embodiments, the receiving module 420 is further configured to add a trigger processing node to the node graph as the target node, wherein the trigger processing node includes at least one of: a trigger setting node for creating a trigger and/or modifying a trigger; a trigger deletion node; or a trigger lookup node.

In some embodiments, the trigger configuration information indicates a triggering condition associated with a trigger to be managed, the triggering condition includes a time condition associated with a triggering time and/or an event condition associated with a triggering event.

In some embodiments, the receiving module 420 is further configured to obtain, via a first control in the configuration window, a natural language text about a target triggering time; and generate, by a language model, an expression associated with the indicated target triggering time based on the natural language text.

In some embodiments, the event condition includes: a first application event within a target application associated with the workflow; and/or a second application event associated with at least one configured application that is different from the target application.

In some embodiments, the receiving module 420 is further configured to present a set of application program interfaces, APIs, associated with an application; and configure the event condition in response to a selection of at least one API of the set of APIs, the event condition including an application event corresponding to the selected at least one API.

In some embodiments, the trigger configuration information indicates a target workflow bound to a trigger to be managed such that the target workflow is triggered to execute in response to a triggering condition of the trigger being met.

In some embodiments, the trigger configuration information indicates an association between at least one parameter associated with a trigger to be managed and at least one variable in the workflow.

In some embodiments, the at least one variable is associated with a processing request received by the workflow.

In some embodiments, the receiving module 420 is further configured to receive a selection of a preset node in the node graph as the target node, the preset node including a start node of the workflow.

In some embodiments, the apparatus 400 further includes an element presentation module configured to present an indication element associated with the at least one node in response to at least one node in the node graph being associated with a trigger creation action.

In some embodiments, the apparatus 400 further includes an information presentation module configured to present a trigger viewing interface associated with the workflow; and present description information of at least one trigger associated with the workflow in the trigger viewing interface.

In some embodiments, the apparatus 400 further includes a processing module configured to delete the first trigger in response to a first operation on a first trigger of the at least one trigger or execute the second trigger in response to a second operation on a second trigger of the at least one trigger.

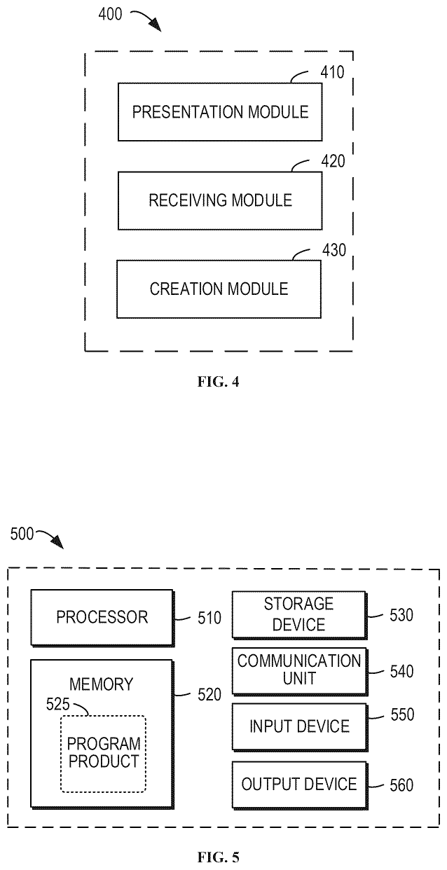

FIG. 5 illustrates a block diagram of an electronic device 500 in which one or more embodiments of the present disclosure may be implemented. It should be understood that the electronic device 500 illustrated in FIG. 5 is merely as an example and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, non-volatile magnetic disk (e.g., a “floppy disk”) and an optical disk drive for reading or writing from a removable, non-volatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is implemented to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executable by a processor to implement the method described above. According to example implementations of the present disclosure, a computer program product is further provided, the computer program product being tangibly stored on a non-transitory computer-readable medium and including computer-executable instructions, while the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of various blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce an apparatus to implement the functions/acts specified in one or more blocks in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks in the flowchart and/or block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in one or more blocks in the flowchart and/or block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are examples, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for creating a workflow, comprising:
presenting a canvas component for editing a node graph of a workflow;
receiving, via the canvas component, an editing operation associated with the node graph and for configuring at least one action associated with the workflow, the at least one action configured to manage a trigger associated with the workflow; and
creating the workflow based on the editing operation.

2. The method of claim 1, wherein the at least one action comprises at least one of:
a creation action for creating a new trigger associated with the workflow;
a deletion action for deleting an existing trigger associated with the workflow;
a modification action for modifying an attribute of an existing trigger associated with the workflow; or
a lookup action for looking up at least one trigger associated with the workflow.

3. The method of claim 1, wherein receiving an editing operation associated with the node graph comprises:
presenting a configuration window associated with a target node in the node graph; and
obtaining, via a configuration window, a trigger configuration information associated with the target node.

4. The method of claim 3, wherein receiving an editing operation associated with the node graph further comprises:
adding a trigger processing node to the node graph as the target node,
wherein the trigger processing node comprises at least one of: a trigger setting node for creating a trigger and/or modifying a trigger; a trigger deletion node; or a trigger lookup node.

5. The method of claim 3, wherein the trigger configuration information indicates a triggering condition associated with a trigger to be managed, the triggering condition comprises a time condition associated with a triggering time and/or an event condition associated with a triggering event.

6. The method of claim 5, wherein obtaining a trigger configuration information associated with the target node via a configuration window comprises:
obtaining, via a first control in the configuration window, a natural language text about a target triggering time; and
generating, by a language model, an expression associated with the target triggering time based on the natural language text.

7. The method of claim 5, wherein the event condition comprises:
a first application event within a target application associated with the workflow; and/or
a second application event associated with at least one configured application that is different from the target application.

8. The method of claim 7, wherein obtaining a trigger configuration information associated with the target node via the configuration window comprises:
presenting a set of application program interfaces, APIs, associated with an application; and
configuring the event condition in response to a selection of at least one API of the set of APIs, the event condition comprising an application event corresponding to the selected at least one API.

9. The method of claim 3, wherein the trigger configuration information indicates a target workflow bound to a trigger to be managed such that the target workflow is triggered to execute in response to a triggering condition of the trigger being met.

10. The method of claim 3, wherein the trigger configuration information indicates an association between at least one parameter associated with a trigger to be managed and at least one variable in the workflow.

11. The method of claim 10, wherein the at least one variable is associated with a processing request received by the workflow.

12. The method of claim 3, wherein receiving an editing operation associated with the node graph further comprises:
receiving a selection of a preset node in the node graph as the target node, the preset node comprising a start node of the workflow.

13. The method of claim 1, further comprising:
presenting an indication element associated with at least one node in response to the at least one node in the node graph being associated with a trigger creation action.

14. The method of claim 1, further comprising:
presenting a trigger viewing interface associated with the workflow; and
presenting description information of at least one trigger associated with the workflow in the trigger viewing interface.

15. The method of claim 14, further comprising:
in response to a first operation on a first trigger of the at least one trigger, deleting the first trigger; or
in response to a second operation on a second trigger of the at least one trigger, executing the second trigger.

16. An electronic device, comprising:
at least one processor; and
at least one memory coupled to the at least one processor and storing instructions for execution by the at least one processor, wherein the instructions, when executed by the at least one processor, cause the electronic device to perform operations comprising:
presenting a canvas component for editing a node graph of a workflow;
receiving, via the canvas component, an editing operation associated with the node graph and for configuring at least one action associated with the workflow, the at least one action configured to manage a trigger associated with the workflow; and
creating the workflow based on the editing operation.

17. The electronic device of claim 16, wherein the at least one action comprises at least one of:
a creation action for creating a new trigger associated with the workflow;
a deletion action for deleting an existing trigger associated with the workflow;
a modification action for modifying an attribute of an existing trigger associated with the workflow; or
a lookup action for looking up at least one trigger associated with the workflow.

18. The electronic device of claim 16, wherein receiving an editing operation associated with the node graph comprises:
presenting a configuration window associated with a target node in the node graph; and
obtaining, via a configuration window, a trigger configuration information associated with the target node.

19. The electronic device of claim 16, wherein the operations further comprise:
presenting an indication element associated with at least one node in response to the at least one node in the node graph being associated with a trigger creation action.

20. A non-transitory computer-readable storage medium having stored thereon a computer program executable by a processor to implement a method comprising:
presenting a canvas component for editing a node graph of a workflow;
receiving, via the canvas component, an editing operation associated with the node graph and for configuring at least one action associated with the workflow, the at least one action configured to manage a trigger associated with the workflow; and
creating the workflow based on the editing operation.
